(19) United States
(12) Patent Application Publication
(10) Pub. No.: US 2007/0148040 A1
(43) Pub. Date: Jun. 28, 2007

(54) Pipette tip indicator

(76) Inventor: Anna Wong, Sacramento, CA (US)

Correspondence Address: J. CURTIS EDMONDSON, P.O. BOX 571, CLAREMONT, CA, 91711, US

(21) Appl. No.: 11/318,770

(22) Filed: Dec. 27, 2005

(51) Int. Cl. G01N 31/22

(52) U.S. Cl. 422/58; 422/100

(57) ABSTRACT

This invention relates to a color indicator for pipette tips that aids in the removal of the supernatant from extraction tubes where it is difficult to differentiate the tip of clear or translucent pipette from the clear opaque tube containing supernatant and the pellet. The colorized tip may also be sold as an assembly with color-coded extraction tubes for identification purposes.

### CROSS REFERENCE TO RELATED APPLICATIONS

None

### FEDERALLY SPONSORED RESEARCH

None

### BACKGROUND

1. Field of the Invention

This invention relates to the field of liquid extraction and dispensing devices in general and pipettes in particular.

2. Description of the Related Art

A pipette is typically used to transfer liquids from one container to another. In a typical pipette operation the user will insert the pipette into a test tube, a centrifuge tube, or a microcentrifuge tube (See FIG. 1A), create a negative air pressure on the pipette using the a mechanical device or a one piece pipette and plunger unit, drawing up liquid in the process (See FIG. 1B). This is followed by removal of the pipette from the test tubes, centrifuge tubes, or microcentrifuge tubes; insertion of the pipette into another test tube (See FIG. 1C), then releasing the air pressure, allowing the liquids into the test tube (See FIG. 1D).

One of the difficulties of liquid extraction using a pipette involves test tubes, centrifuge tubes, or microcentrifuge tubes; that have both a liquid portion and a solid or semi-solid portion. The solid portion is typically formed when a liquid sample is centrifuged. The centrifuge process creates a lighter liquid portion called the supernatant and a heavier solid portion called a pellet. Some extraction processes require the user to only remove the supernatant of the test tube, the centrifuge tube, or the microcentrifuge tube, without disturbing the pellet. This is a serious enough problem that common introductory biology classes advise students to be aware of this problem (see http://www.ruf.rice.edu/-bioslabs/studies/sds-page/gellabl.html ), stating ‘It is often difficult to see where the supernatant ends and the pellet begins, thus there is a risk of sucking the membranes up as the supernatant is discarded. If it becomes difficult to distinguish where the pellet begins, one can stop part way through the removal of supernatant, resuspend everything, and recentrifuge’).

Clearly a problem can exist during the manual extraction of the supernatant when a pellet is present.

In a particular example, the process of PCR extraction involves extracting the supernatant and preserving the pellet. The type of pipette used in PCR extraction is usually a polypropylene pipette. The polypropylene pipette typically consists of a clear or translucent pipette coupled with an extraction syringe or built in plunger unit. The extraction syringe or built in plunger unit creates the negative air pressure necessary to draw liquids through the clear or opaque pipette. The pipette is inserted into a tube (see Eppendorf, Inc). The tube itself is usually made of polypropylene and is clear or translucent allowing the user to see the supernatant and the pellet.

One of the difficulties in the extraction process involves insertion of the pipette into the tube. The tube is made of a clear or translucent plastic with little surrounding contrast. The pipette likewise is made of a clear or translucent plastic. The difficulty arises due to the lack of contrast between the two materials. When a person holds the tube in one hand and inserts the pipette into the tube, it is difficult to see the end of the pipette. The problem is that if the tip of the pipette is improperly positioned then there is a risk of touching the pellet with the tip of the pipette, thereby destroying the experiment.

For example, there are a number of manufacturers and distributors of pipettes and transfer pipettes, with or without tubes in a disposable and non-disposable fashion. Eppendorf produces a number of pipettes (See http://www.eDpendorfna.com/products/?LVL=4&PHDPNK=002006071) that are used with the 0.2 and 0.5 ml tubes (See http://www.eppendorfna.com/products/PCR tube de.asp?PHDPNK=00300605904 8). Also, Diagger, VWR, and other laboratory vendors are distributors of these tubes and pipettes.

U.S. Pat. No. 6,955,180 (2005) to Kocherlakota, et al. describes color coded gangs of holes which are color coded, but fails to describe a pipette tip that is color coded. U.S. Pat. No. 6,852,283 (2005) to Acosta , et al. describes guide holes that are color coded, but, does not describe the color coding of pipettes themselves.

U.S. Pat. No. 5,344,036 (1994) to Stanescu, et al. describes a colorized disk on a vial, but does not describe the disk in conjunction with a pipette that is colored

U.S. Pat. No. 5,218,875 (1993) to Volpe, et al. describes color on a pipette assembly, but specifically states that the tip should remain clear and is simply used for identification purposes.

Currently there has been no apparatus or methods created to reduce the risk of disturbing the pellet during manual or mechanical extraction of liquids using a pipette.

Whereas the pipette is simply one type of liquid dispensing devices that are inserted into containers for the purposes of extracting liquids. There are many other types of devices that operate in a similar fashion to pipettes.

It is an object of this invention to an easier means for position liquid dispensing or extraction devices in containers where there is currently little contrast between the tip of the liquid dispensing or extraction devices, the container, and the liquid being drawn into the device by placing a color indicator on the tip of the liquid dispensing device.

It is another object of this invention to provide a color tip that is not uniform such that it may improve the differentiation between the color coating, the container, and the tip of the liquid dispensing or extraction devices.

It is another object of this invention to provide an assembly that consists of a liquid dispensing or extraction devices with a color tip and a container marked with the same color so that the liquid dispensing or extraction devices and the container may be identified together.

### BRIEF DESCRIPTION OF THE DRAWINGS

FIGS. 1A through 1D are prior art depicting the four step process of extracting liquids using a pipette.

FIG. 2 are pipettes, color indicated at the tip, to aid in the visual identification of the location of the tip as it is inserted into the extraction tube.

FIG. 3 is a pipette, color marked at the tip, positioned in the extraction tube after the process of centrifuging, so that it is easier to view the color tip. The pellet is also depicted in proximity to the tip of the pipette.

FIGS. 4a and 4b is a close up view of the pipette showing alternate embodiments of the pipette.

### DETAILED DESCRIPTION

While describing the invention and its embodiments various terms will be used for the sake of clarity. These terms are intended to not only include the recited embodiments, but also all equivalents that perform substantially the same function, in substantially the same manner to achieve the same result.

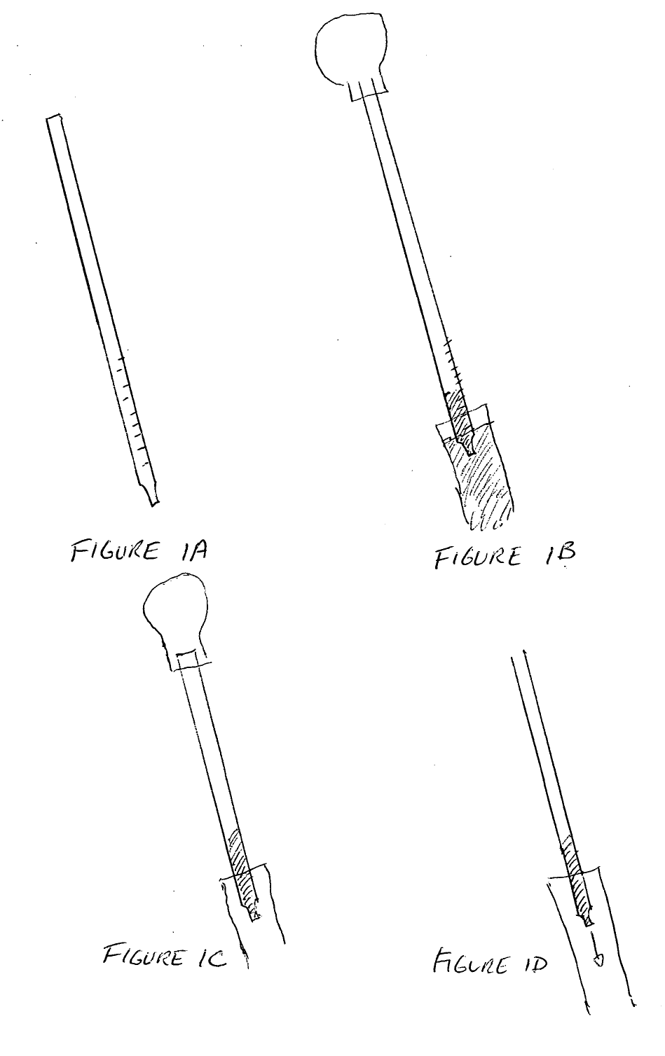

FIGS. 1A through 1D as described in the Background Section provides a process of extracting the supernatant from a tube using a pipette.

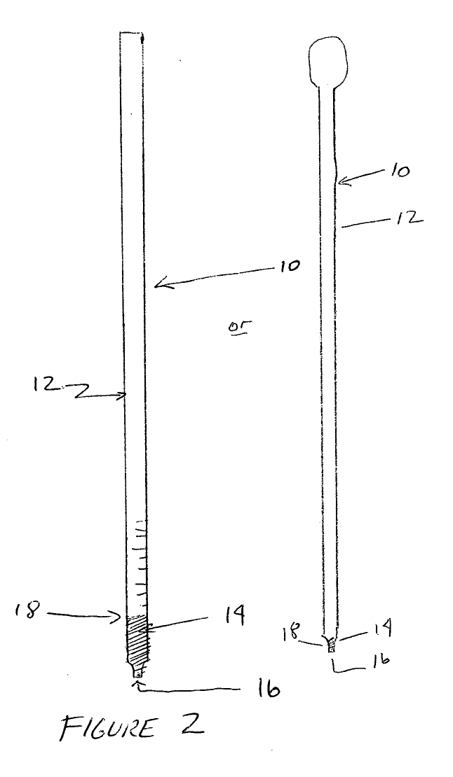

FIG. 2 provides an example of the modified pipette 10. The modified pipette 10 consists of a standard pipette 12 with a coating 14. The coating 14 extends approximately from the bottom of the pipette 12 near the tip 16 to a point 18 on the pipette 12.

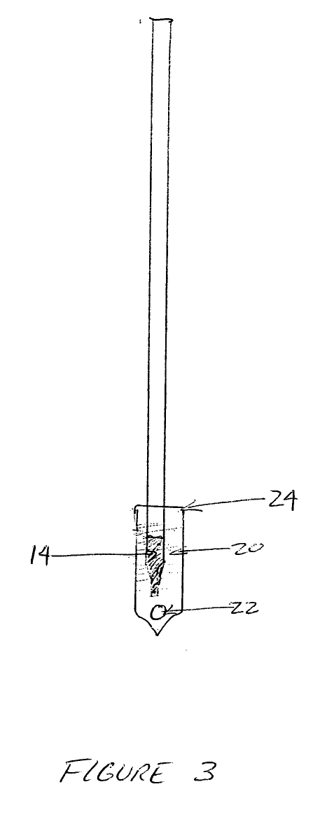

As shown in FIG. 3, the color of the coating 14 can be selected from a group of colors that provide differentiation between the supernatant 20 and the pellet 22 that are in the extraction tube 24.

The coating 14 should be of a density to allow a view of the liquid drawn up in the pipette 12 through the supernatant 20.

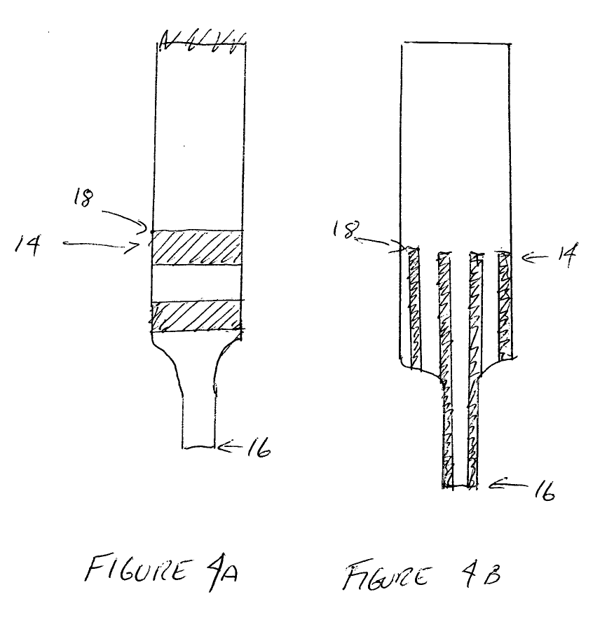

As shown in FIGS. 4a and 4b, the coating 14 does not need to be continuous from the tip 16 to a point 18 on the pipette 12. Also the coating 14 does not need to be the same color on the pipette 12.

Lastly, the color on the coating 14 may also serve to identify the pipette 12 for a particular use. For example, it may be useful to have a pipette 12 with a color coating 14 of “red” to be only used with extraction tube 24 with the same color “red”.

I claim:

1. A liquid dispensing device tip indicator which comprises:
a top, a tip, a shaft, a hollow core;
and a color indicator placed on said shaft;
said color indicator located at or near the tip of said liquid dispensing device.

2. A device as in claim 1 wherein the density of said color coating varies in density between lightly tinted and darkly tinted.

3. A device as in claim 1 wherein said color indicator is uniform.

4. A device as in claim 1 wherein said color indicator comprises of interleaved bands of color coating and a lack of coating.

5. A method of using a liquid dispensing device as in claim 1 consisting of:
a) Applying a color indicator to the tip of the liquid dispensing device using an indelible marking device;
b) Inserting said tip of the liquid dispensing device into an extraction tube, said container consisting of a supernatant and pellet, and using the color indicator to position said tip of the liquid dispensing device without disturbing the pellet.

6. An pipette and tube assembly comprising
a) a liquid dispensing device which comprises:
a top, a tip, a shaft, a hollow core;
and a color indicator placed on said shaft;
said color indicator located at or near the tip of said liquid dispensing device;
b) a test tube

7. The assembly as in claim 6 wherein said test tube is selected from a group consisting of test tubes, centrifuge tubes, and microcentrifuge tubes.
